(19) United States
(12) Patent Application Publication
(10) Pub. No.: US 2003/0046274 A1
(43) Pub. Date: Mar. 6, 2003

(54) Software media container

(76) Inventors: John S. Erickson, Norwich, VT (US); Mark Schlageter, Merrimack, NH (US)

Correspondence Address: HEWLETT- PACKARD COMPANY, INTELLECTUAL PROPERTY ADMINISTRATION, P.O. BOX 272400, FORT COLLINS,, CO, 60527-2400, US

(21) Appl. No.: 09/941,606

(22) Filed: Aug. 30, 2001

(51) Int. Cl. G06F 7/00

(52) U.S. Cl. 707/3

(57) ABSTRACT

The present invention provides a single “container” for storing and/or transporting electronic data, the container including data (externally of the “container”) which is universally readable and/or decipherable and which can be used to specify to the wide range of different applications the format of the encapsulated data, reference the rights management technology used to package the data, and provide policies in order to obtain and interpret the data content.

### FIELD OF THE INVENTION

This invention relates to a software media container and, in particular, to a software media container format for securely containing electronic content, the container beings particularly suitable for use in digital rights management applications involving electronic policy enforcement and copyright protection mechanisms.

### BACKGROUND TO THE INVENTION

Copyright is an intellectual property right which gives rights to the creators of certain kinds of material, so that they can control the various ways in which their material may be exploited. It is intended to protect original literary, dramatic, musical and artistic works, published editions of works, sound recordings, films (including videograms) and broadcasts (including cable and satellite broadcasts), and the rights afforded by copyright broadly cover copying, adapting, issuing copies to the public, performing in public and broadcasting such protected material. In many cases, the author will also have the right to be identified on his work, and object to mutilations and distortions of his work. Further, a rental right is given to owners of copyright in sound recordings, films and computer programs and therefore the exploitation of such works by renting them to the public requires a licence from the copyright owner.

In recent years, it has become increasingly common to store content such as sound recordings, literary works and films electronically, and the commercial distribution of electronic content such as this traditionally takes place through retail outlets, such as record or book shops. Commercial distribution of electronic content over an information technology network has many advantages, but has not yet been widely adopted by creators and commercial distributors of such content, largely because of fears relating to the resultant increase in potential ease with which such content may be illicitly reproduced, sold and distributed by third parties. For this reason, significant effort has been directed toward the development of technological safeguards which prevent unauthorised copying of electronic content.

Digital content is relatively easy to copy illegally, which is both advantageous and disadvantageous for content providers in the sense that on the one hand it is desirable for the content to be distributed as widely as possible (thereby increasing its value and therefore the potential revenues to be gained therefrom), but they still want to ensure that they are paid for each sale, i.e. they do not want piracy taking place. In order to prevent piracy, as stated above, the content providers are inclined towards the use of digital protection schemes (which are normally based on encryption techniques) which are a) difficult to use for consumers and restrict distribution, b) expensive to manage, and c) possibly undercut by free, illegal schemes which provide the same content with an easier user experience.

One known protection scheme is provided by the Microsoft Digital Media System in which electronic content is provided with a key, with a corresponding key being required to be obtained from an authorised key server before the user can play the content. One of the main disadvantages of this scheme is that it is tightly bound to the user's player, in the sense that special equipment is required by the user if they wish to play the content protected by this scheme.

In general, many known digital rights management and protection schemes involve substantial encryption of material, making it difficult to copy, and/or difficult to play copied content. Digital rights management (DRM) technologies in current use make themselves apparent to users either as secure containers, i.e. they define their own proprietary file format, inside of which they securely encapsulate an arbitrary media file.

For example, U.S. Pat. No. 6,138,119 describes techniques for defining, using and manipulating rights management data structures in which the concept of a secure digital container is used for safely and securely storing and transporting digital content. Such containers are tamper-resistant containers which can be used to package any kind of digital information, such as for example, text, graphics, executable software, audio and/or video. However, this approach limits the context in which secured content may be used.

An alternative type of system provides a “plug-in” security function to a particular media format (such as Adobe™ PDF). Although the software plug-in business model has been used successfully for years to extend applications in other specific markets, such as video and audio (pluggable codecs), multimedia (pluggable executables that “extend” programs), creativity tools (filters that extend image processing tools) and Web browsers, currently only Adobe Acrobat™ provides a security function with which third-party developers can uniformly develop DRM systems that operate within a particular format. However, the approach used in this system is limited by the media capabilities of the target format (PDF), i.e. this approach limits, to a single format, the number of media types that may be secured.

One of the main considerations in the field of digital rights management (or DRM) is that of interoperability, i.e. a solution which allows arbitrary media content to be provided in a format to which a number of different arbitrary DRM policies can be applied as required. In other words, there is requirement for some manner in which media content can be stored and transported which maintains security against piracy, but does not limit the number of media types which may be handled in this way, and the present invention addresses this issue and seeks to overcome the problems outlined above.

### SUMMARY OF THE INVENTION

Thus, in accordance with a first aspect of the present invention, there is provided a secure electronic media container for storing, transporting and/or providing a rights management interface to electronic media content, said container having said electronic media content stored therein and data, externally of but attached to or otherwise associated with said container, representative of the media handler and/or a rights management mechanism required to open and play said content.

In accordance with a second aspect of the present invention, there is provided apparatus for handling the contents of a secure container as defined according to the first aspect of the present invention in which is stored electronic media content of arbitrary format, the apparatus comprising means for determining from said external data what, if any, digital rights management mechanism was used to package said content and for retrieving or otherwise accessing an appropriate digital rights management handler accordingly, means for passing said content through said DRM handler, means for determining from said external data the media handler required to access and handle the content and for retrieving or otherwise accessing an appropriate media handler, and means for passing said content through said media handler.

Also in accordance with the second aspect of the present invention, there is provided a method of handling the contents of a secure container as defined according to the first aspect of the present invention in which is stored electronic media content of arbitrary format, the method comprising the steps of reading the external data and determining what, if any, digital rights management mechanism was used to package said content, retrieving or otherwise accessing an appropriate digital rights management handler accordingly, passing said content through said DRM handler, reading the external data and determining the media handler required to access and handle the content, retrieving or otherwise accessing an appropriate media handler, and passing said content through said media handler.

The concept of a secure container is well known in the art and, for the purposes of this specification, will be defined broadly in terms of an abstract data container format for containing data, the data being encrypted or otherwise arranged within the container having a notional package or “wrapper” surrounding and protecting the stored data, such that it can only be restructured for use by a specific software program adapted especially for the format in question. In the case of prior art secure containers, none of the data, nor any information relating thereto, is accessible or restructurable externally of the container except by means of the specific software program referred to above.

On the other hand, the present invention provides a secure container in the form of a universal “envelope” or meta-container which allows for arbitrary media formats and arbitrary DRM mechanism. This is achieved by attaching or otherwise binding metadata to a secure container containing media content, the metadata being generally universally readable and/or decipherable and describing the underlying media format and digital rights management mechanism(s) employed to ‘package’ the content, so that a processing application (for example, a desktop software tool, web browser, etc.) can evaluate the handling requirements of container, retrieve processing components (if necessary), retrieve and render copyright ownership information, and apply designated copyright management policies.

Interoperability is easier to achieve using the concept of the present invention because the format of the “outer” layer of the media container (which can be thought of as the package or “wrapper” itself, can be standardised, and provide a mechanism whereby a variety of DRM vendors could create “plug-in” solutions based upon their different value propositions. Each of these DRM plug-ins could be arranged to apply their proprietary protocols as required to deliver whatever DRM user interfaces, key management, transactional messaging, etc. are required. These would appear as functional extensions to the media rendering application of interest.

### BRIEF DESCRIPTION OF THE DRAWINGS

An embodiment of the present invention will now be described by way of example only with reference to the accompanying drawings, in which:

FIG. 1 is a schematic block diagram illustrating the functional ability of an exemplary embodiment of the present invention; and

FIG. 2 is an exemplary DRM file format according to the invention.

### DETAILED DESCRIPTION OF THE INVENTION

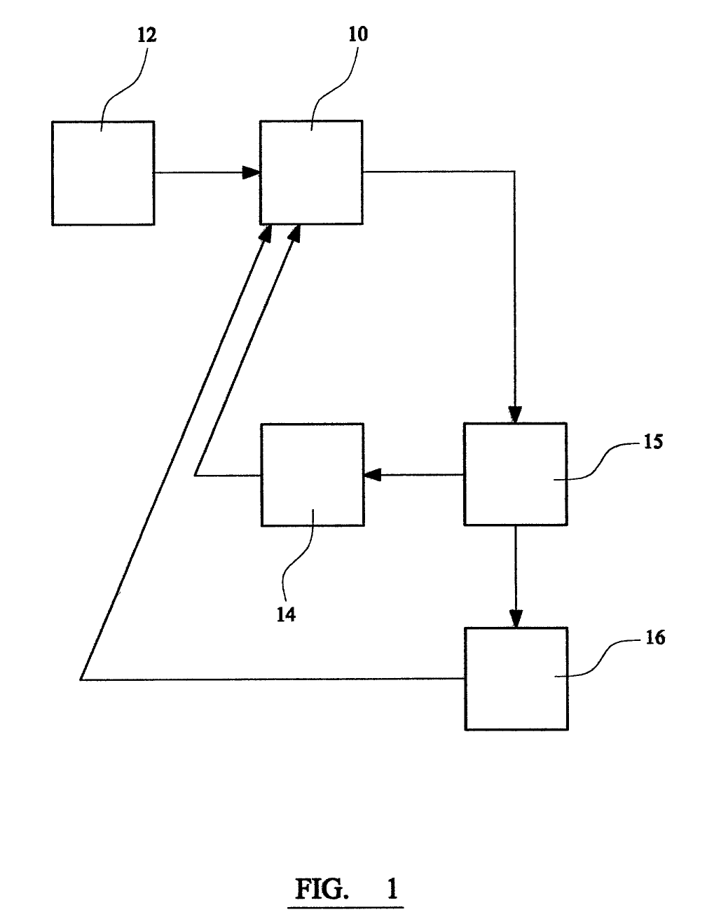

Referring to FIG. 1 of the drawings, consider the situation whereby a user 10 is sent a secure container 12 containing electronic content, such as a sound recording. Because the data is contained within a secure container 12, particular software is required to restructure and play the sound recording. A generic container handler 15 retrieves details (if any)of the DRM mechanism used to package the data within the secure container 12 and details of the media handler required to handle the data, said details being attached to the outer layer of the container 12 as metadata, together with details of how (or where) the required media handler and DRM handler can be obtained (if appropriate). The content is first passed through the specified DRM handler 14 and then through the specified media handler, such that the sound recording can now be played by the user and appropriate DRM policies can be applied accordingly.

Thus, the DRM format specification (included in the metadata) indicates how the generic container (or envelope) handler 15 should recognise, reference and/or retrieve (if necessary) the required media handler(s) 16 and, in particular, how to recognise and reference particular DRM handlers or plug-ins. The DRM mechanism may be referenced in a way which is similar to the manner in which MIME types are currently handled.

How container and/or media handlers communicate with their respective host applications occurs at a different level, is known in the art, and will not be discussed in any further detail herein. When the DRM format handler opens a file in which a DRM mechanism has been specified, it calls the specified plug-in or remote service to handle it, but what that plug-in or service does and how it communicates with the user and on the network is not relevant here and varies between programs. This provides the advantage of enabling arbitrary media formats, such as Word, MP3, PDF, HTML, etc. to be chosen as ‘mark-up’, and packaged with an arbitrary security solution. In other words, the present invention can be considered to provide format-level DRM interoperability, which allows participants to appear to use the same media formats, whereas they are really using a secure container having a wrapper in a format defined by the present invention.

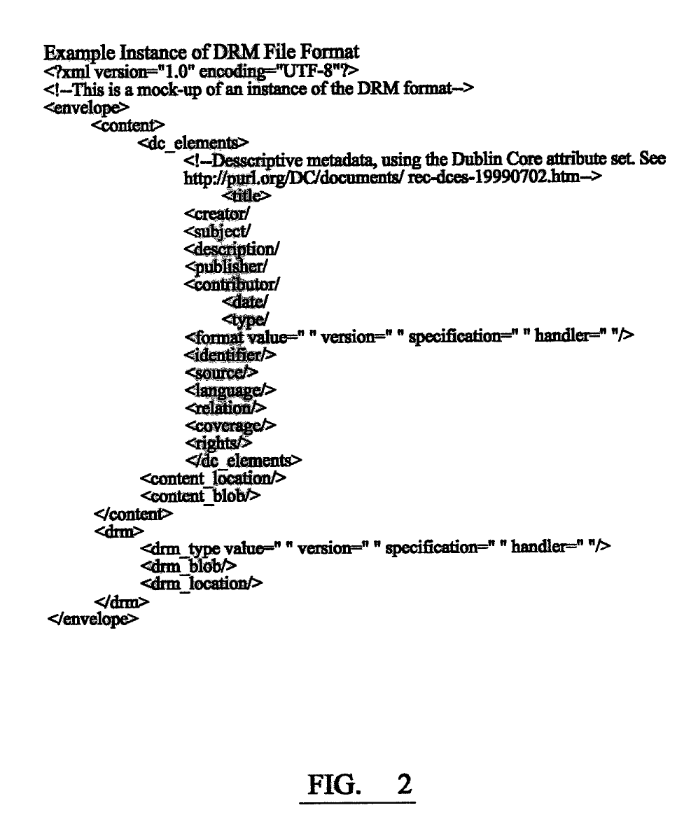

Referring to FIG. 2 of the drawings, an exemplary markup format according to the present invention will now be described in more detail.

A container according to an exemplary embodiment of the present invention, typically using structured markup syntax such as XML, has at least a <CONTENT> section and a <DRM> section.

The <CONTENT> section specifies the format (e.g. the MIME type) of the content. This section can either encapsulate the content (possibly as hex-encoded “blob”), or preferably by indirection through a network resource address (e.g. URL or DOI). Other elements in the <CONTENT> section would include descriptive metadata, an optional reference to the web location of a format specification, and an optional reference to the location of the “rendering” code registry.

The <DRM> section specifies the DRM mechanism employed, typically a media-specific encryption mechanism, to package the content. The specified mechanism would either be contained or referenced in the <CONTENT> section, and the DRM reference would refer to either an installed component on the local system or a distant component or web service. Thus, the DRM format may specify that a local encrypted content blob should be sent to a distant DRM web service for processing, or a remote encrypted content stream should be decrypted by a remote web service, a remotely sourced stream should be processed by a local resource.

The processing sequence for elements within a <DRM> container (file or stream) are always the <DRM> element(s) followed by the <CONTENT> element. Thus, when a calling application opens the outer DRM envelope and determines that a DRM mechanism has been specified, it knows by the given definition of the DRM format that it must first pass the content through the specified DRM mechanism (like a filter) and then must call the appropriate media handler to handle the content type. Such a handling model allows advanced applications such as multi-step DRM mechanisms, with the content being passed through a series of DRM mechanisms as specified.

It should be noted that the appropriate handling of the object's media type is dependent upon the application. For example, in the particular case whereby the handler is responsible for “transcoding” an HTML file with <DRM> objects embedded, the correct method for “handling” might actually be to inject appropriate HTML tags for the specified MIME type of the content in the output stream.

In one possible implementation, the DRM mechanism can hand over a metadata structure (e.g. XML file) that it has “extracted” from the content, by way of its processing. This might then be augmented by the media handler (e.g. due to the native rights metadata that has been embedded). Regardless, the calling a proxy server apparatus (app) received a XML-fornatted (say) specification of how the DRM mechanism “says” it should handle the content, if anything. Thus the DRM mechanism can pass “suggestions” to the app on how to control menu items, etc; it is up to the app to actually do this. The controlling metadata is packaged in such a way that if multiple mechanisms are used (the “filter” notion), a set of specifications will end up being passed to the app.

In summary, the present invention provides a single “container” for storing and/or transporting electronic data, the container including data (externally of the “container”) which can be used to specify to a wide range of different applications the format of the encapsulated data, reference the rights management technology used to package the data, and provide policies on how to obtain and interpret the data content.

In the foregoing specification, the invention has been described with reference to specific exemplary embodiments thereof It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. A secure electronic media container for storing, transporting and/or providing a rights management interface to electronic media content, said container having said electronic media content stored therein and data, external of but attached to or otherwise associated with said container, representative of the media handler and/or a rights management mechanism required to open and play said content.

2. Apparatus for handling the contents of a secure container as claimed in claim 1, in which is stored electronic media content of arbitrary format, the apparatus comprising means for determining from said external data what, if any, digital rights management mechanism was used to package said content and for retrieving or otherwise accessing an appropriate digital rights management handler accordingly, means for passing said content through said digital rights management handler, means for determining from said external data the media handler required to access and handle the content and for retrieving or otherwise accessing an appropriate media handler and means for passing said content through said media handler.

3. A secure electronic media container according to claim 1, comprising a secure container containing media content having attached or otherwise bound thereto metadata which is universally readable and/or decipherable and describes the underlying media format and digital rights management mechanism(s) employed to package the content.

4. A secure electronic container according to claim 3, wherein the metadata describing the underlying media format encapsulates the content itself

5. A secure electronic container according to claim 3, wherein the metadata describing the underlying media format includes a remote network resource address at which the content itself is stored.

6. A secure electronic container according to claim 3, wherein said metadata includes descriptive metadata relevant to said content and/or a reference to a resource location of a format specification and/or a reference to the location of a “rendering” code registry.

7. A secure electronic container according to claim 3, wherein said metadata describing the digital rights management mechanism(s) employed to package the content mmay refer to an installed component on a local system or a remote component or network service.

8. A method of handling the contents of a secure container as claimed in claim 1 in which is stored electronic media content of arbitrary format, the method comprising the steps of reading the external data and determining what, if any, digital rights management mechanism was used to package said content, retrieving or otherwise accessing an appropriate digital rights management handler accordingly, passing said content through said digital rights management handler, reading the external data and determining the media handler required to access and handle the contents, retrieving or otherwise accessing an appropriate media handler, and passing said content through said media handler.
